(19) United States
(12) Patent Application Publication
(10) Pub. No.: US 2007/0258801 A1
(43) Pub. Date: Nov. 8, 2007

(54) RAMP COMPATIBLE LIFT

(76) Inventors: Karapet Ablabutyan, Glendale, CA (US); Paul Bark, Canyon Lake, CA (US); Levon Hambardzumyan, Glendale, CA (US); Brent Stratton, Los Angeles, CA (US); Maxine Stratton, Los Angeles, CA (US)

Correspondence Address: PERKINS COIE LLP, POST OFFICE BOX 1208, SEATTLE, WA, 98111-1208, US

(21) Appl. No.: 11/624,399

(22) Filed: Jan. 18, 2007

Related U.S. Application Data
(63) Continuation of application No. 11/614,883, filed on Dec. 21, 2006.
(60) Provisional application No. 60/746,751, filed on May 8, 2006.

(51) Int. Cl. B66F 7/08

(52) U.S. Cl. 414/540

(57) ABSTRACT

A lift suitable for use with vehicles is described. The lift allows access to a ramp stored under the vehicle, while preventing unauthorized use of the lift.

### CROSS-REFERENCE TO RELATED APPLICATIONS

This application is a continuation of U.S. patent application Ser. No. 11/614,883, filed Dec. 21, 2006. This application also claims the benefit of U.S. Provisional Patent Application No. 60/746,751, filed May 8, 2006. Both of these applications are incorporated herein by reference.

### BACKGROUND

Ramps and lifts are two devices commonly used to load and unload a truck. A common type of ramp is stored in a channel under the truck bed when not in use, and can be slid out from the back of the truck when needed. A common type of lift includes a platform that is stowed under the truck bed when not in use, and can be unstowed when needed. In this type of lift, the platform is typically foldable and is coupled to a linkage and an actuator which can raise and lower the platform, as well as stow and unstow the platform.

A truck may have both a ramp and a lift installed and available for use. There are many situations where it may be advantageous to make only the ramp available for use. For example, a truck leasing company may want to make only the ramp available for use so it can rent a truck at a lower price to a customer that needs only a ramp and does not need a lift. However, because the lift and the ramp are both stowed under the truck bed, the lift may block the ramp and prevent the ramp from being used. The lift may need to be partially unstowed before the ramp can be accessed. In this case, disabling the lift is not an option because the lift needs to remain operational so that it can be partially unstowed to allow access to the ramp.

### BRIEF DESCRIPTION OF THE DRAWINGS

FIGS. 1A-1C show one embodiment of a lift in accordance with the present invention in bed level position. FIG. 1A shows an isometric view of the lift. FIG. 1B shows a side view of the lift. FIG. 1C shows a cross-sectional side view of the lift.

FIGS. 2A-2F show the lift in ground position. FIGS. 2A-2C show isometric views of the lift. FIGS. 2D-2F show side views of the lift.

FIGS. 3A-3E show the lift as it is being stowed. FIGS. 3A-3C show cross-sectional side views of the lift. FIGS. 3D-3E show side views of the lift.

FIGS. 4A-4J show the lift in stowed position. FIGS. 4A-4C show isometric views of the lift. FIGS. 4D-4F show cross-sectional side views of the lift. FIG. 4G shows an isometric view from beneath the lift. FIG. 4H shows a back view of the lift. FIG. 4J shows a top view of the lift.

FIGS. 5A-5B show one embodiment of an extension plate suitable for use with the lift. FIG. 5A shows an isometric view of the bottom of the extension plate. FIG. 5B shows a back view of the extension plate.

FIGS. 6A-6B show another embodiment of a lift in accordance with the present invention. FIG. 6A shows an isometric view of the lift. FIG. 6B shows a side view of the lift.

### DETAILED DESCRIPTION OF PREFERRED EMBODIMENTS OF THE INVENTION

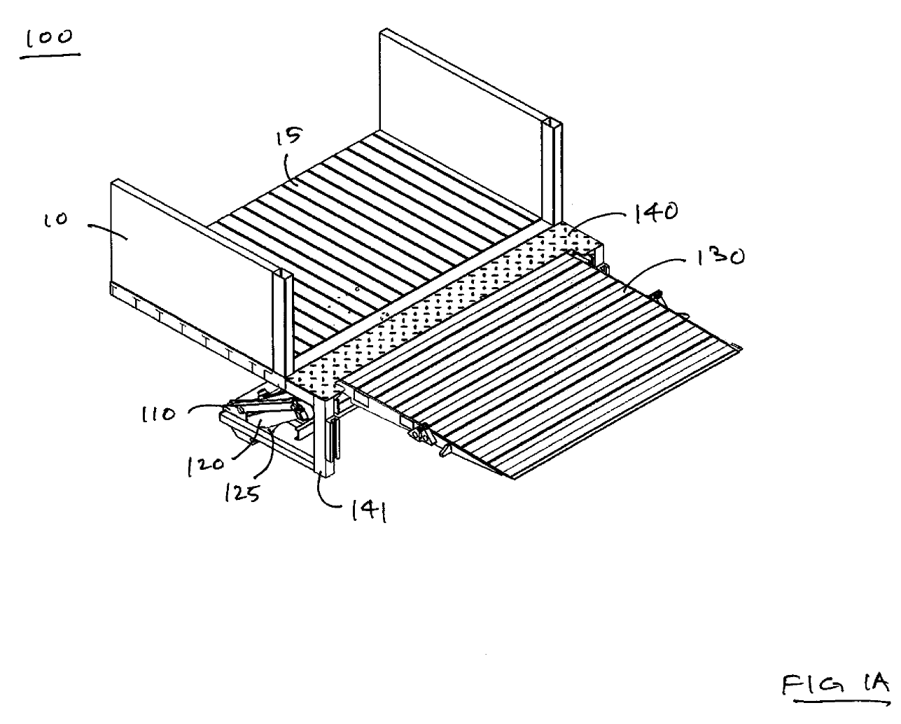

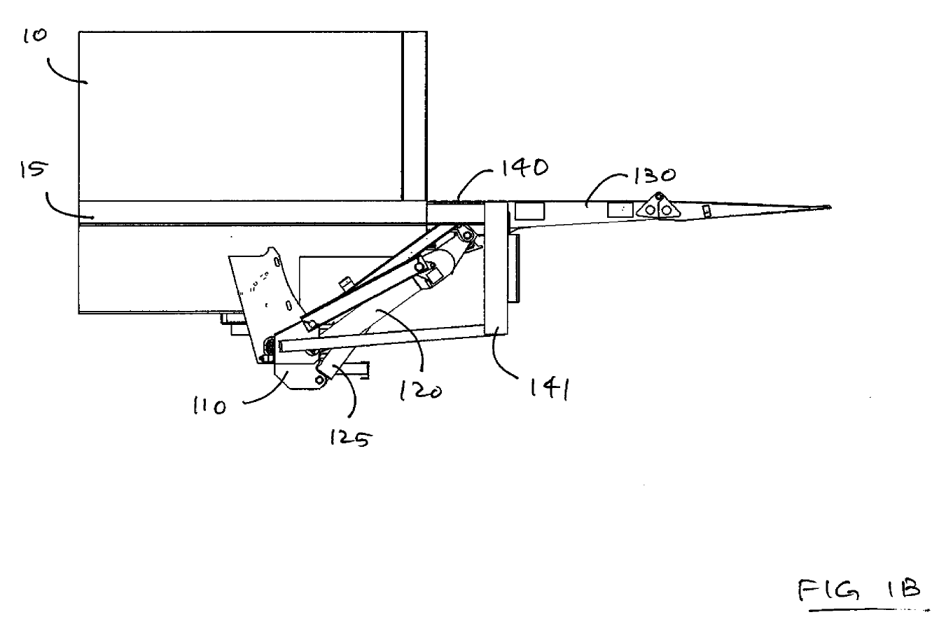

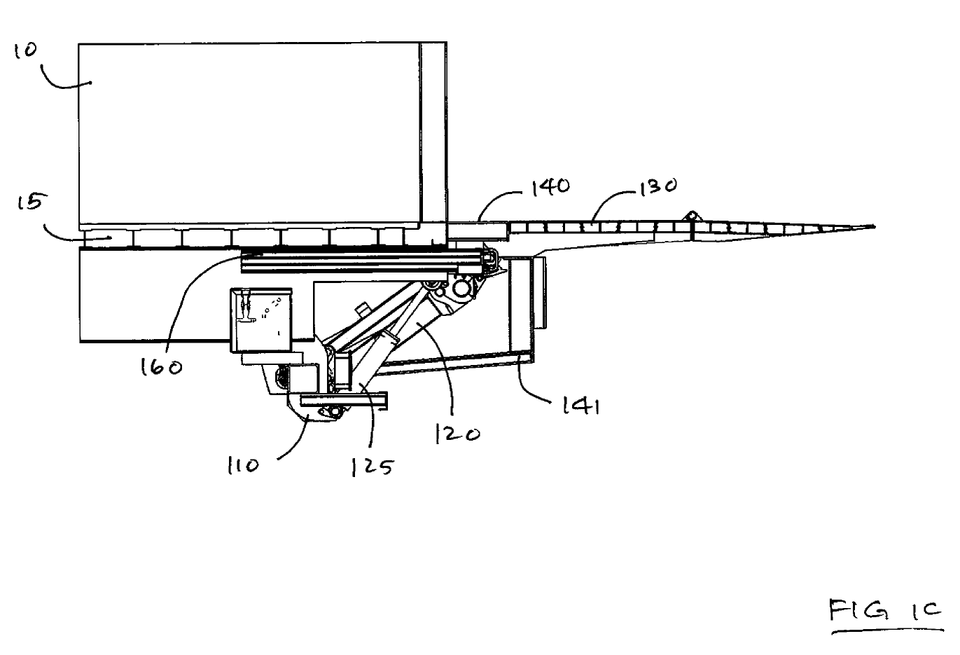

FIGS. 1A-1C show one embodiment of a lift 100 in accordance with the present invention in bed level position. FIG. 1A shows an isometric view of lift 100. FIG. 1B shows a side view of the lift. FIG. 1C shows a cross-sectional side view of lift 100.

Lift 100 includes a frame 110 coupled by a linkage 120 to a platform 130. Frame 110 allows lift 100 to be installed to a vehicle 10. Linkage 120 is coupled to an actuator 125 and can raise and lower platform 130. Platform 130 is foldable and rotatably coupled to linkage 120 for stowing.

Lift 100 may include an extension plate 140 which is coupled to vehicle 10. Extension plate 140 has a top surface that is substantially level with a vehicle bed 15. When lift 100 is in bed level position, platform 130 is substantially level with the top surface of extension plate 140 and vehicle bed 15, and cargo can be moved between platform 130 and vehicle bed 15. Extension plate 140 includes extension plate supports 141.

As shown in FIG. 1B, lift 100 is configured such that linkage 120 does not contact vehicle 10 when lift 100 is in bed level position. As can be seen in FIG. 1C, a ramp 160 may be stored underneath vehicle bed 15.

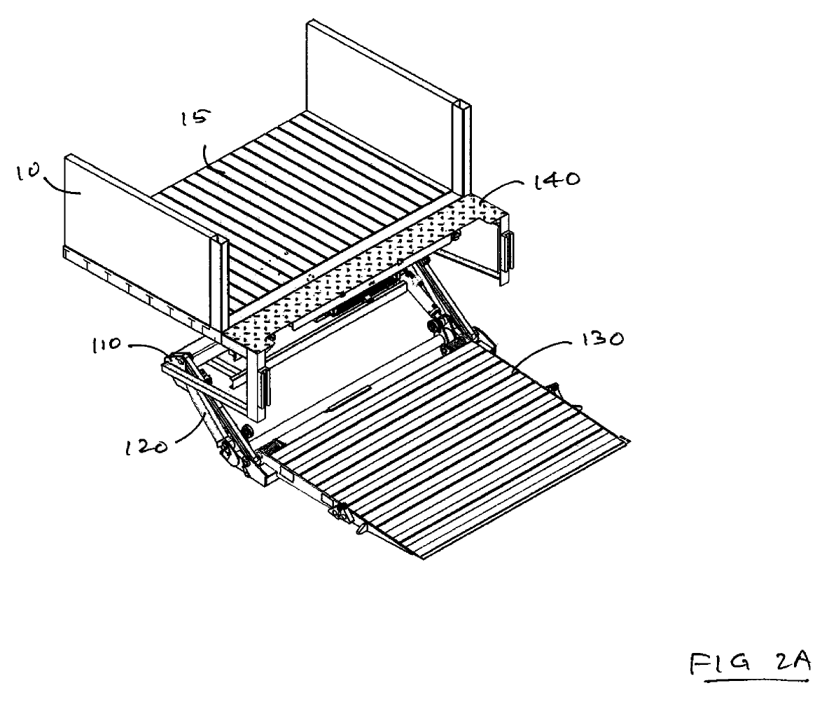

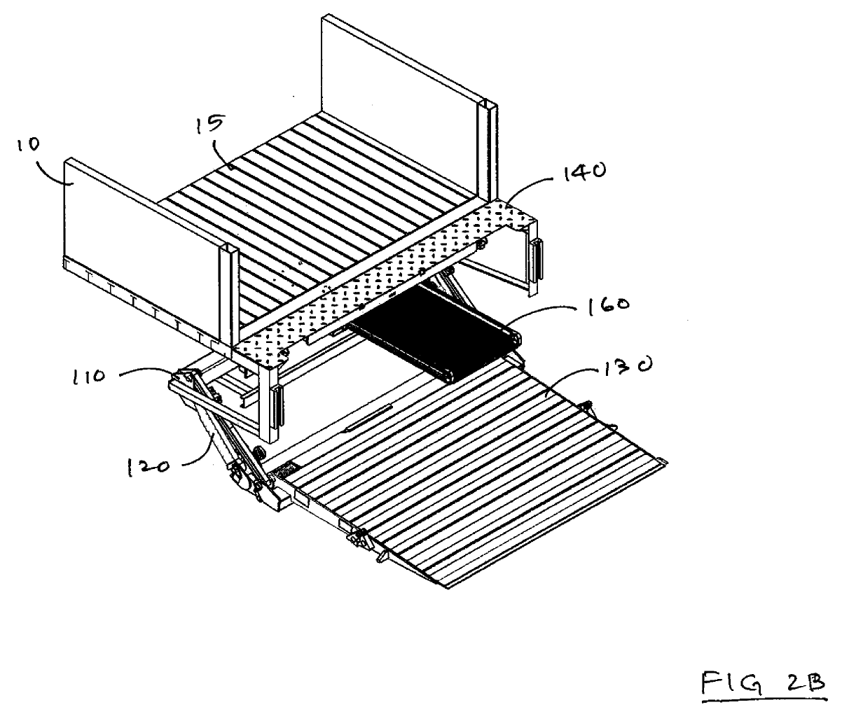

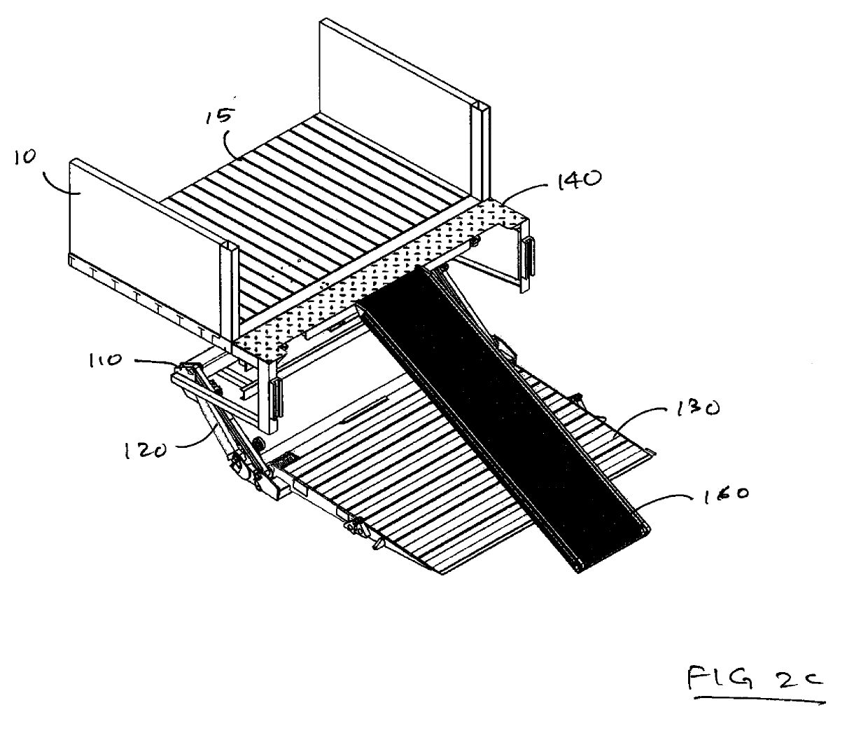

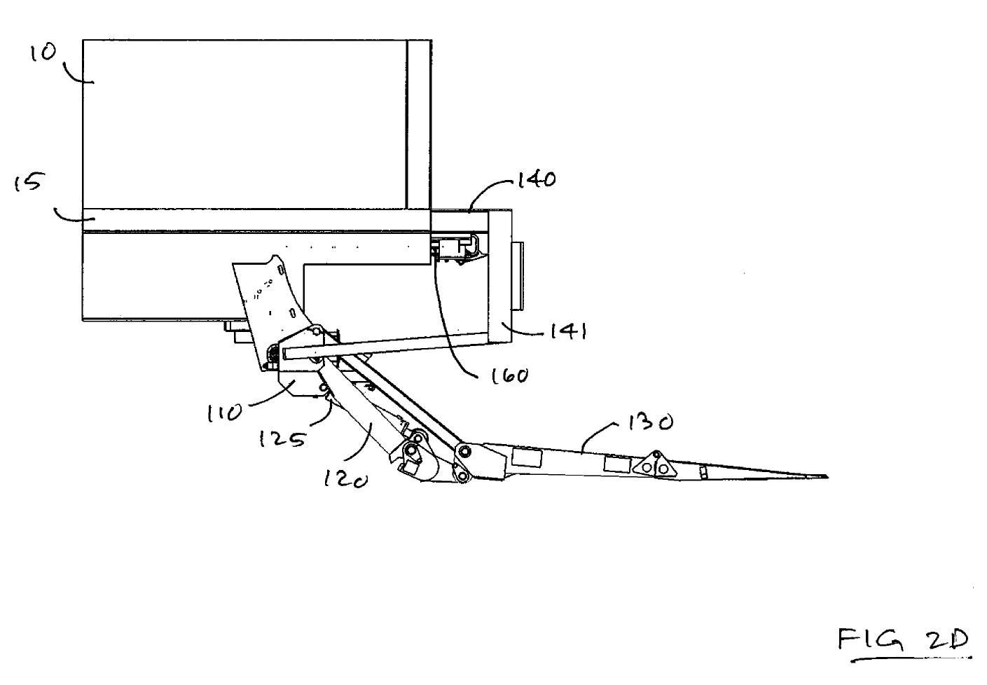

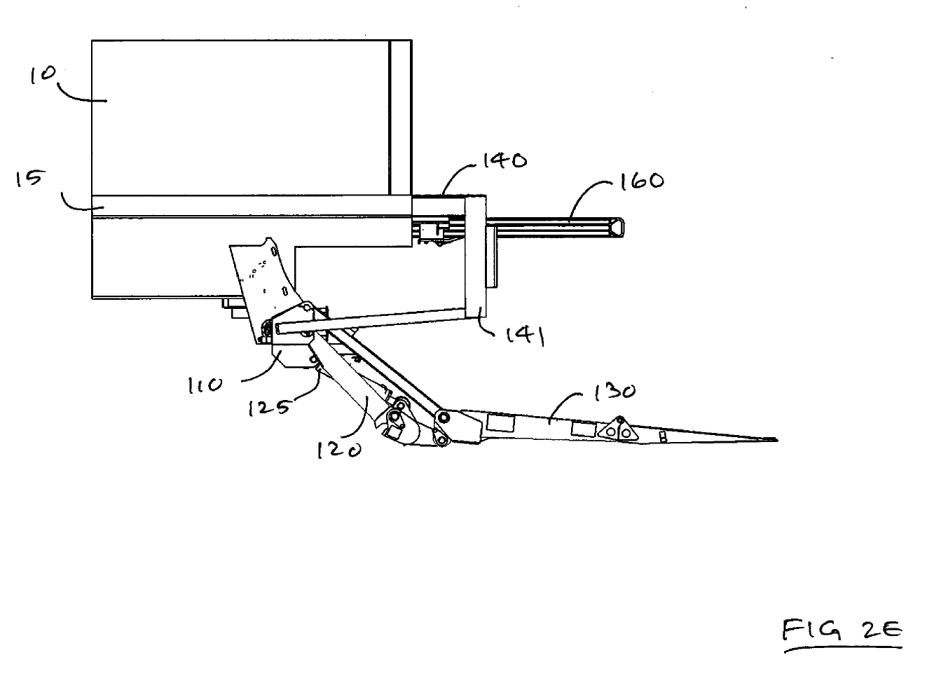

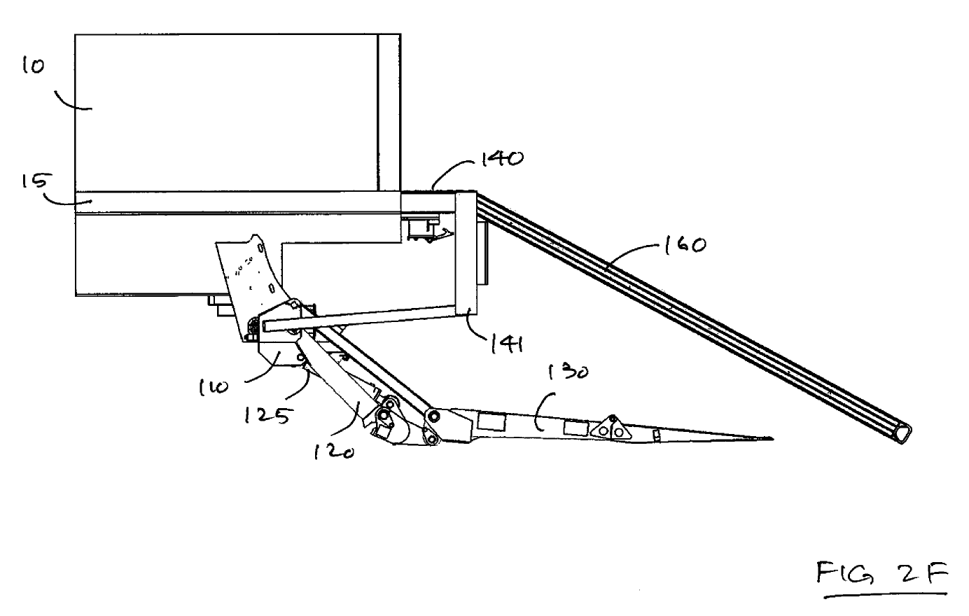

FIGS. 2A-2F show lift 100 in ground position. FIGS. 2A-2C show isometric views of lift 100. FIGS. 2D-2F show side views of lift 100.

When lift 100 is in ground position, platform 130 is near to or on the ground, and cargo can be moved between platform 130 and the ground. Also, ramp 160 may be deployed. Lift 100 may have an interlock which prevents platform 130 from being raised when lift 100 is in ground position and ramp 160 is deployed.

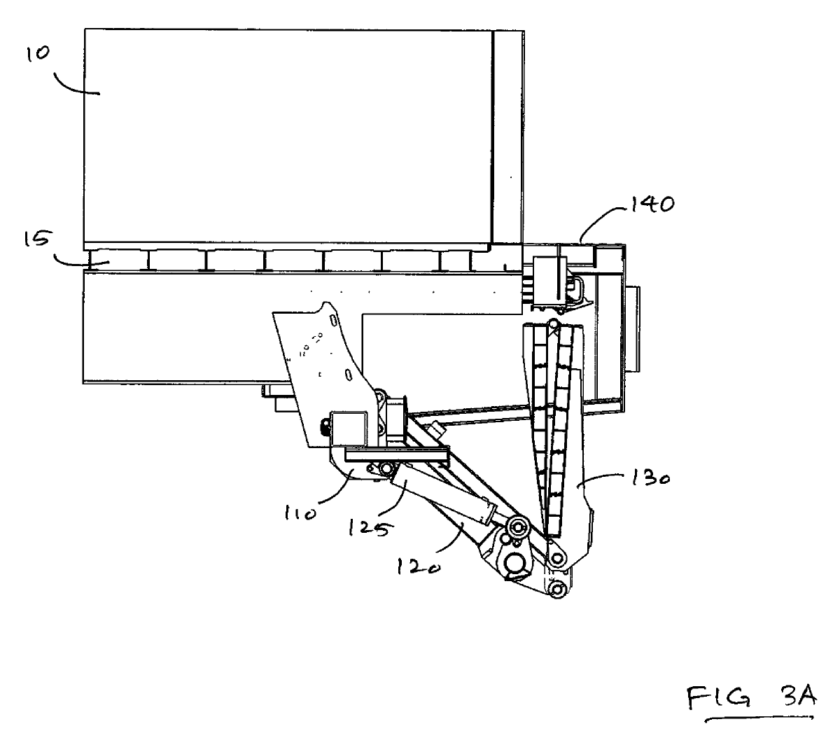

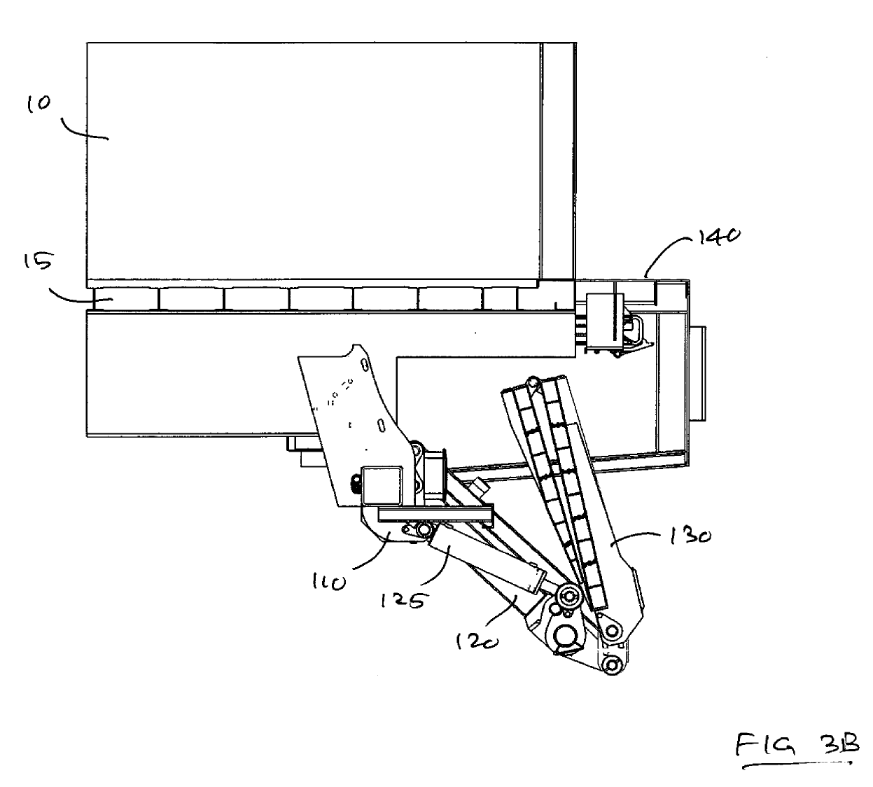

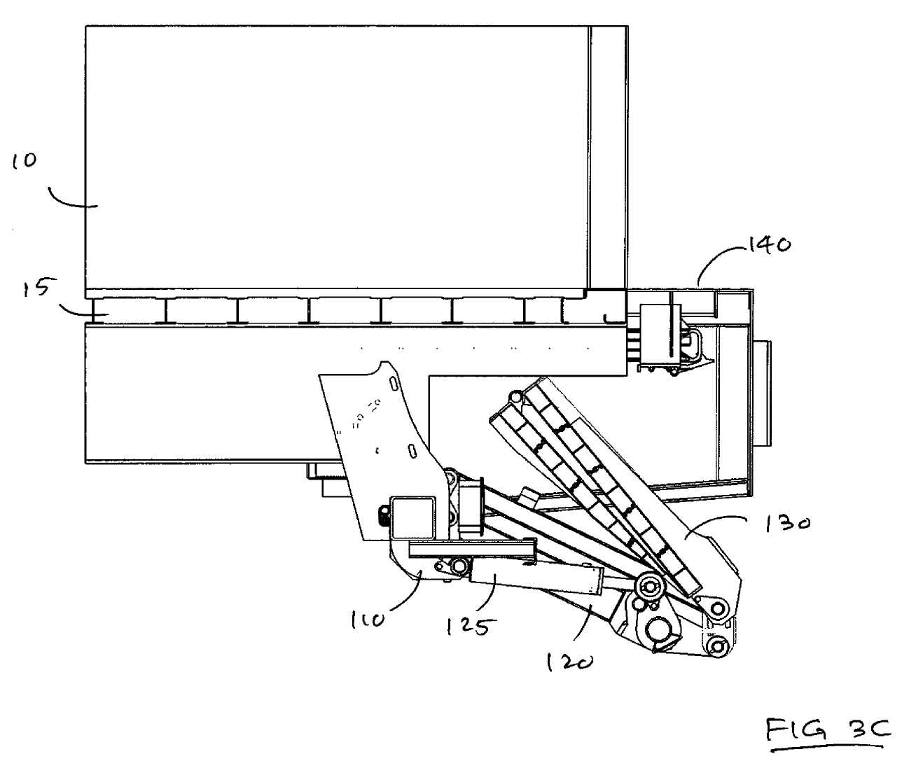

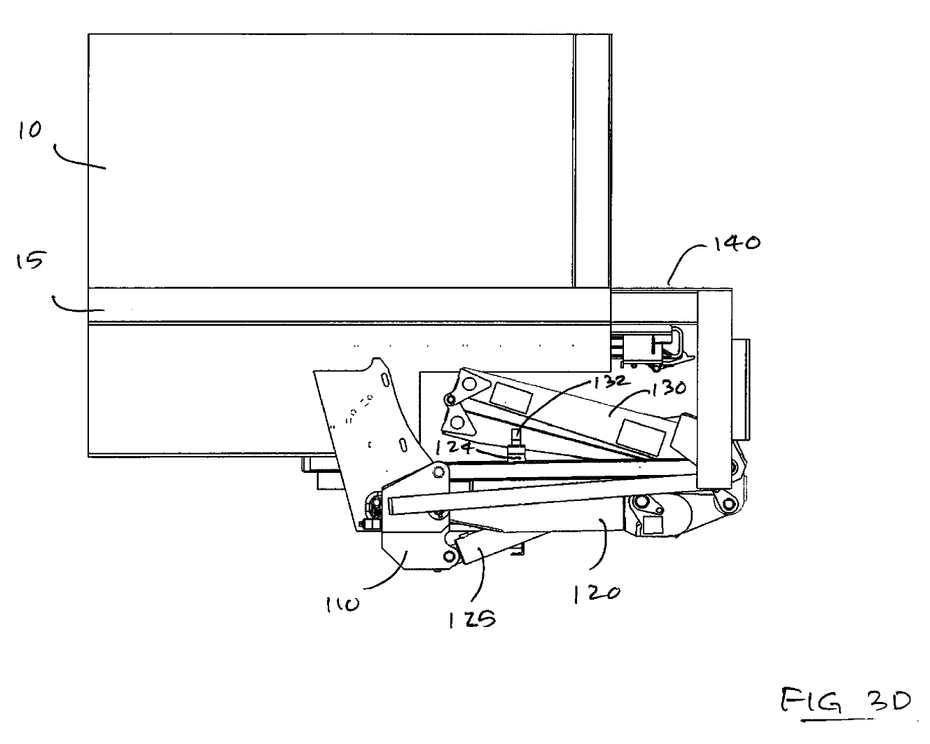

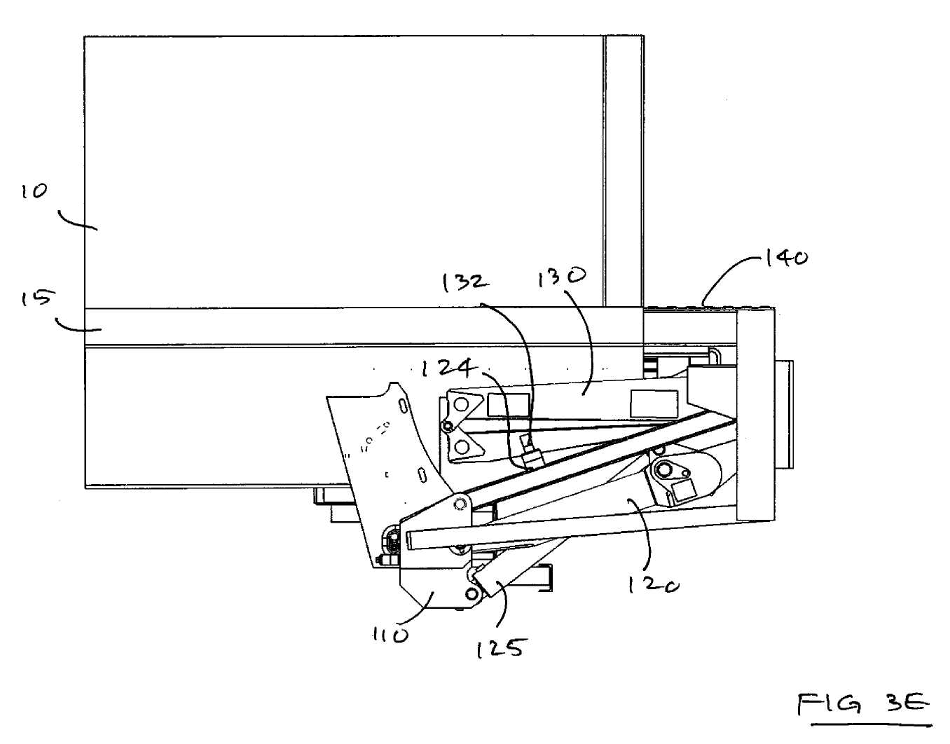

FIGS. 3A-3E show lift 100 as it is being stowed. FIGS. 3A-3C show cross-sectional side views of lift 100. FIGS. 3D-3E show side views of lift 100.

In order to stow lift 100, platform 130 first is folded and rotated as shown in FIG. 3A. Platform 130 continues to be rotated without contacting vehicle 10 until it rests against a roller 126 as shown in FIGS. 3B-3C. Linkage 120 is then raised as shown in FIG. 3D, until platform 130 is “tucked” underneath vehicle bed 15 as shown in FIG. 3E. As platform 130 is stowed, platform 130 is supported by platform supports 124. In this particular embodiment, platform 130 includes platform tabs 132 which rest on platform supports 124 coupled to linkage 120.

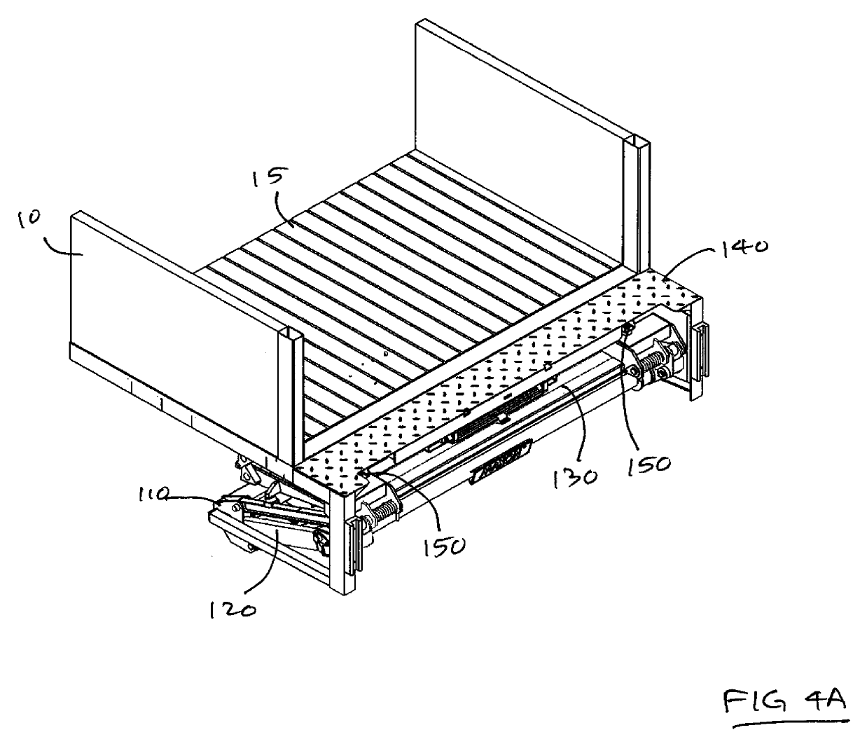

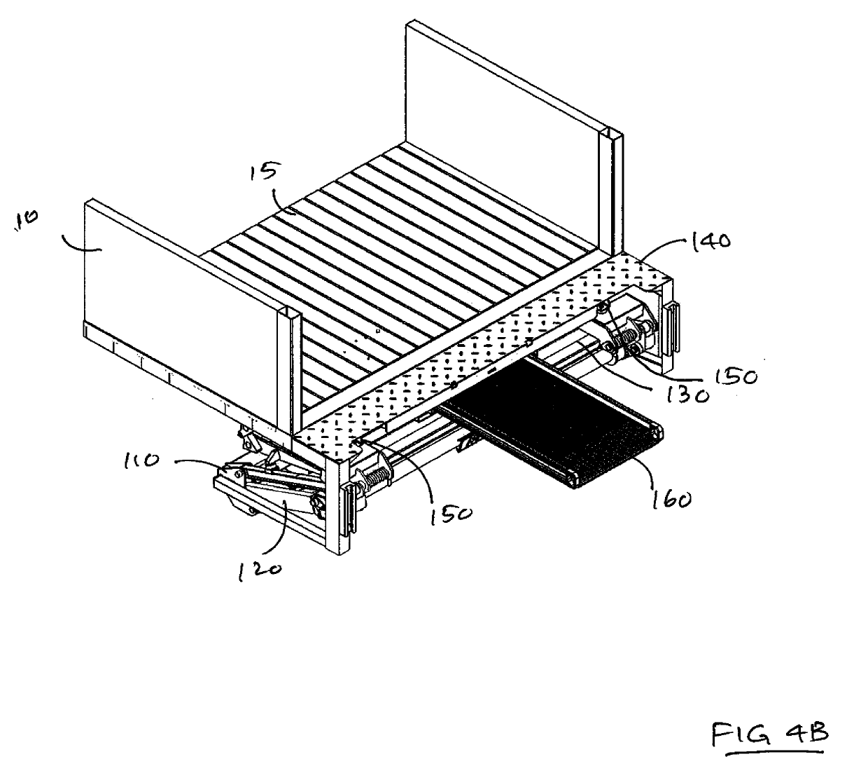

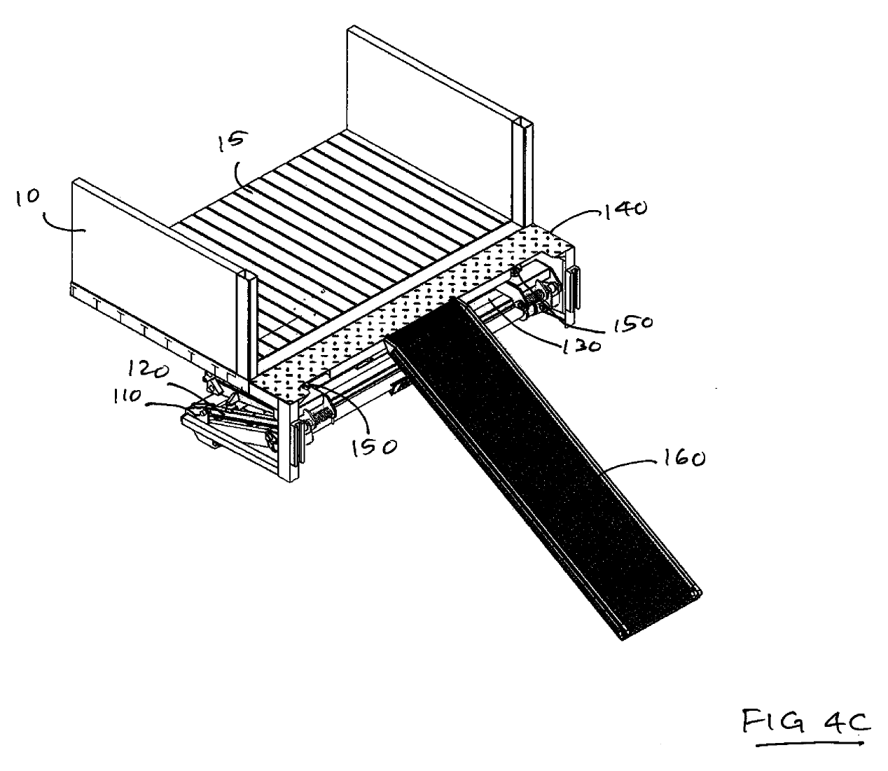

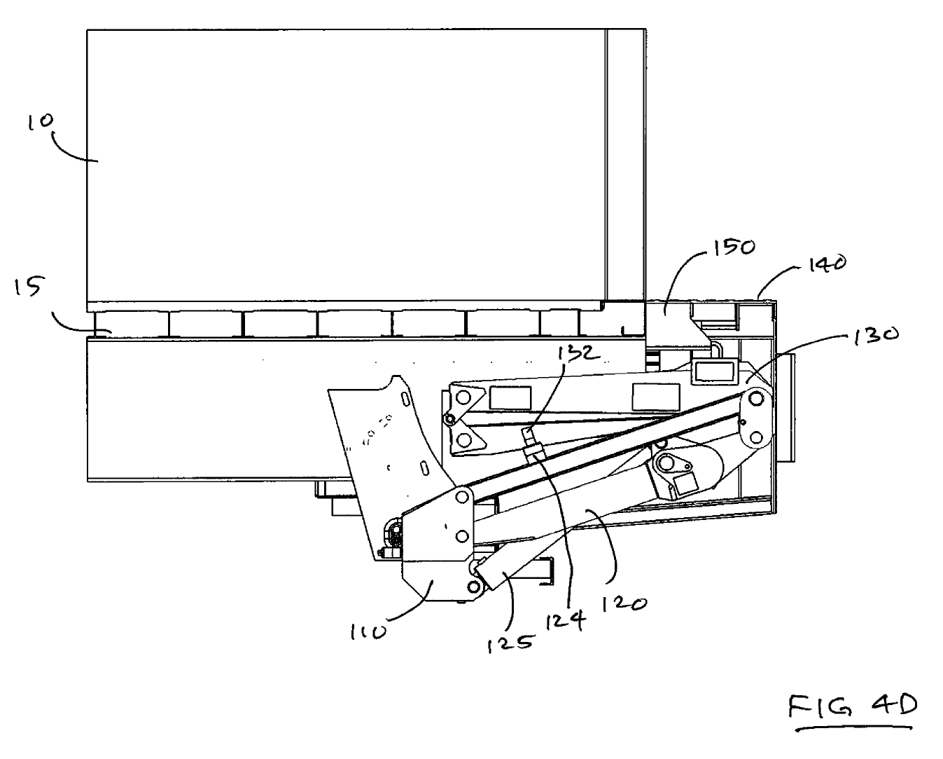

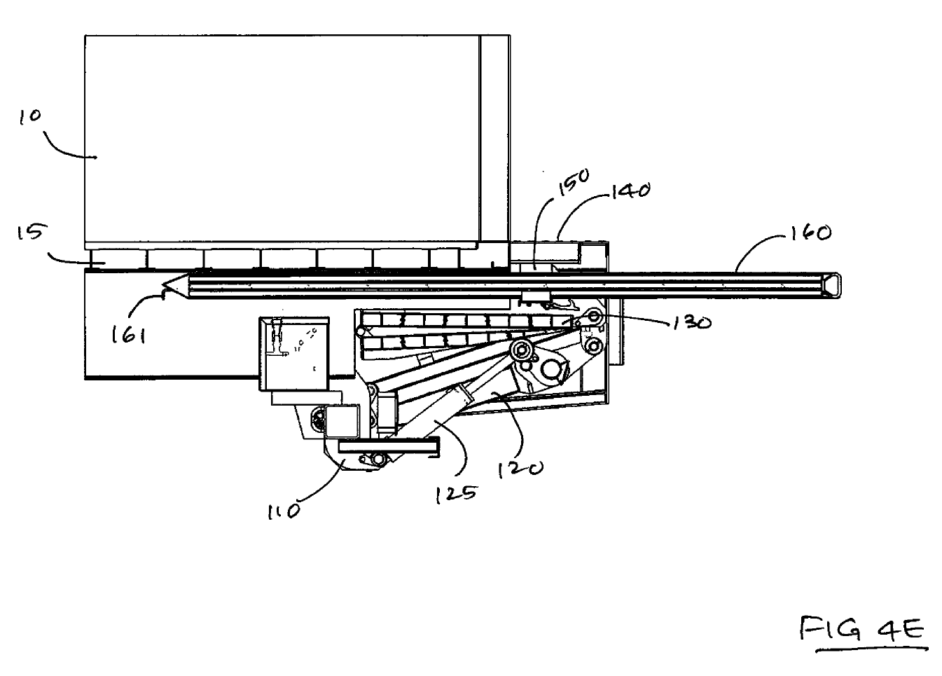

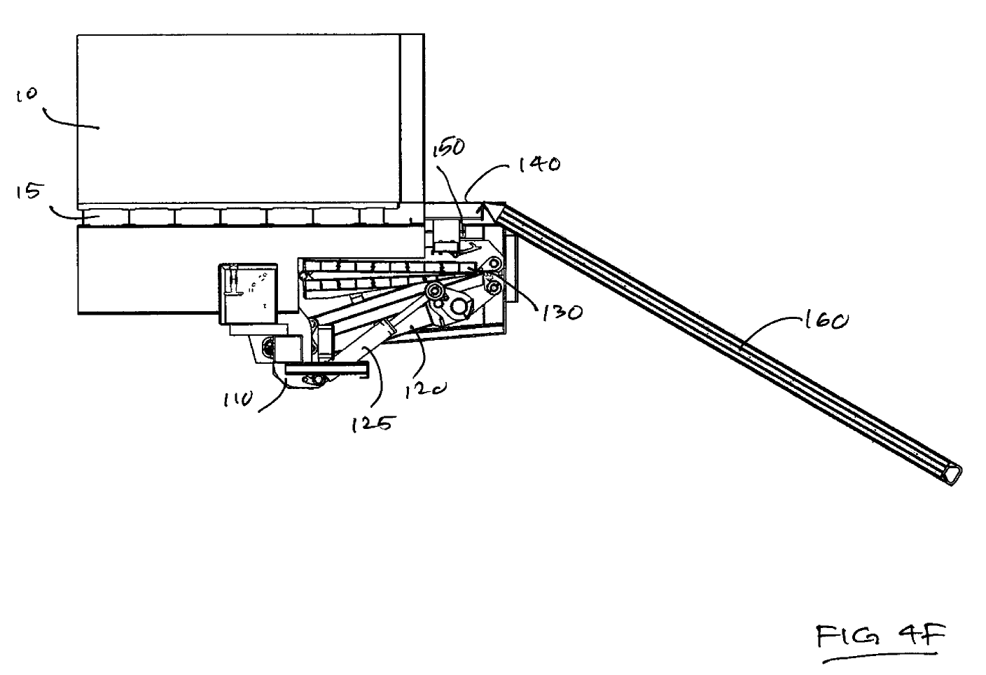

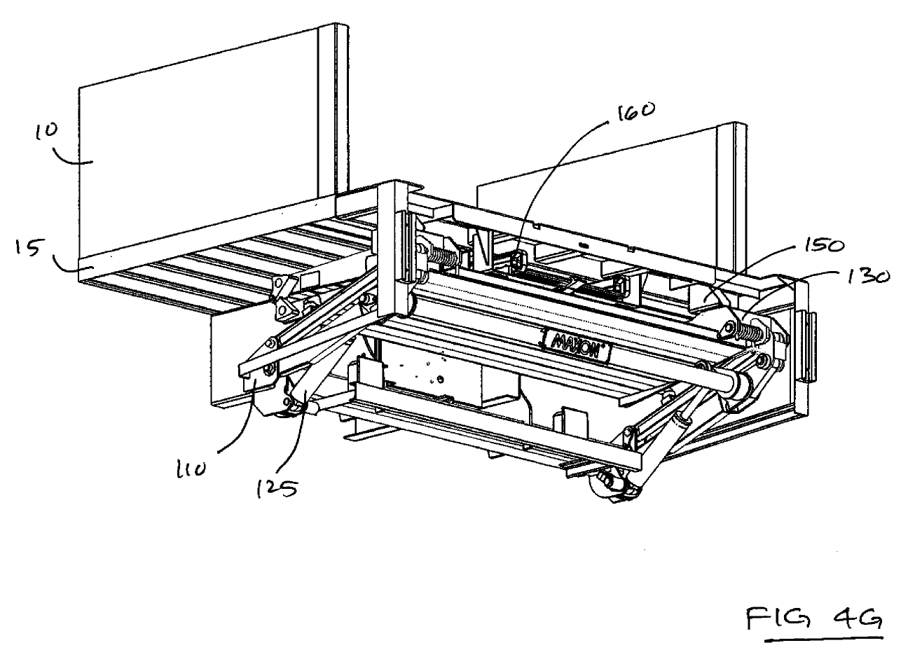

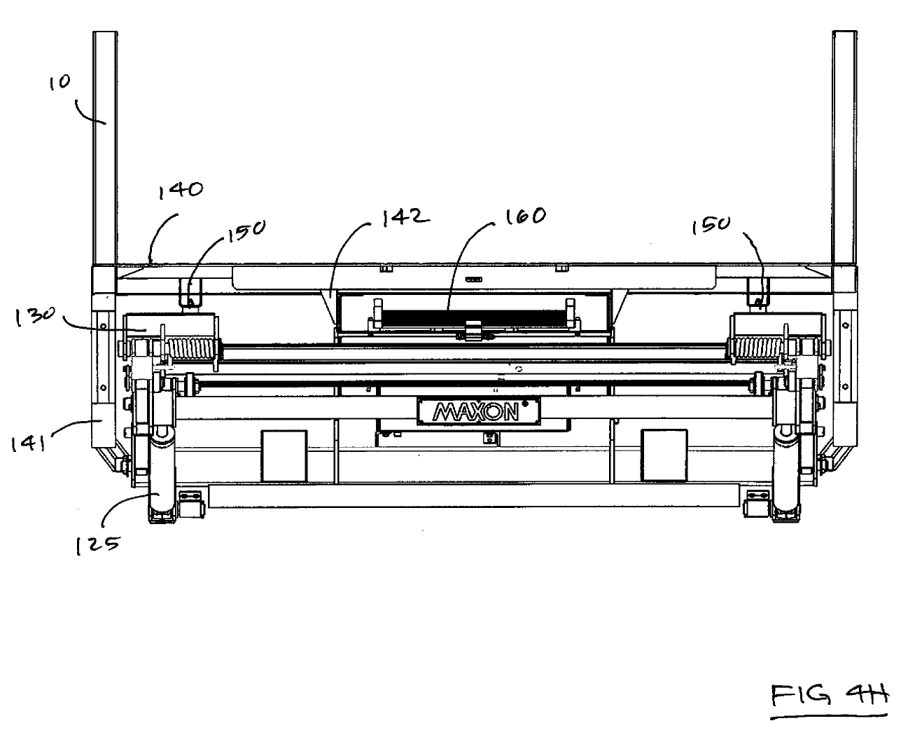

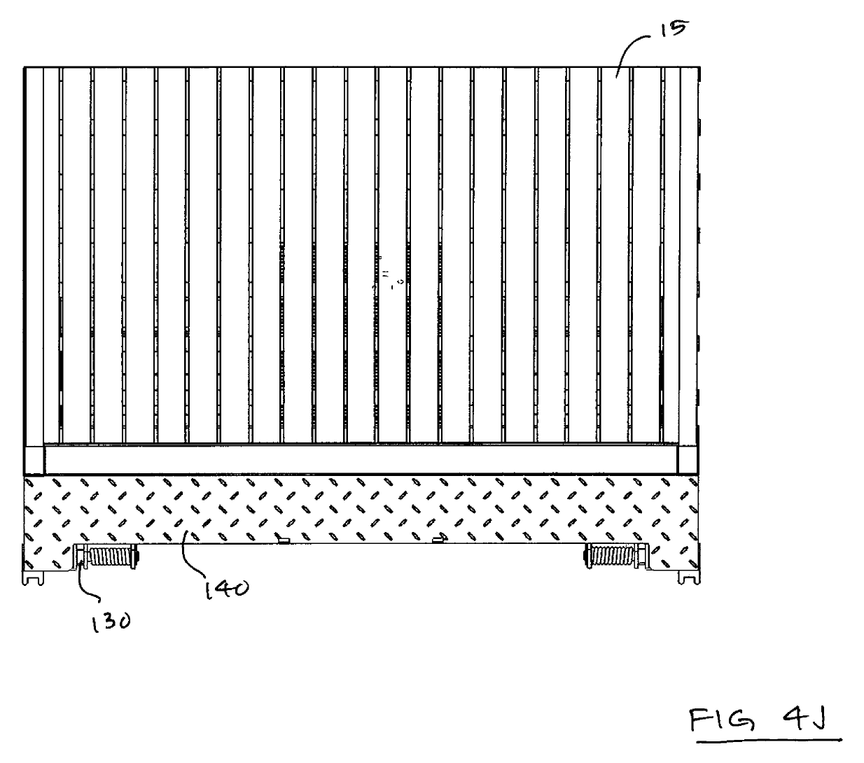

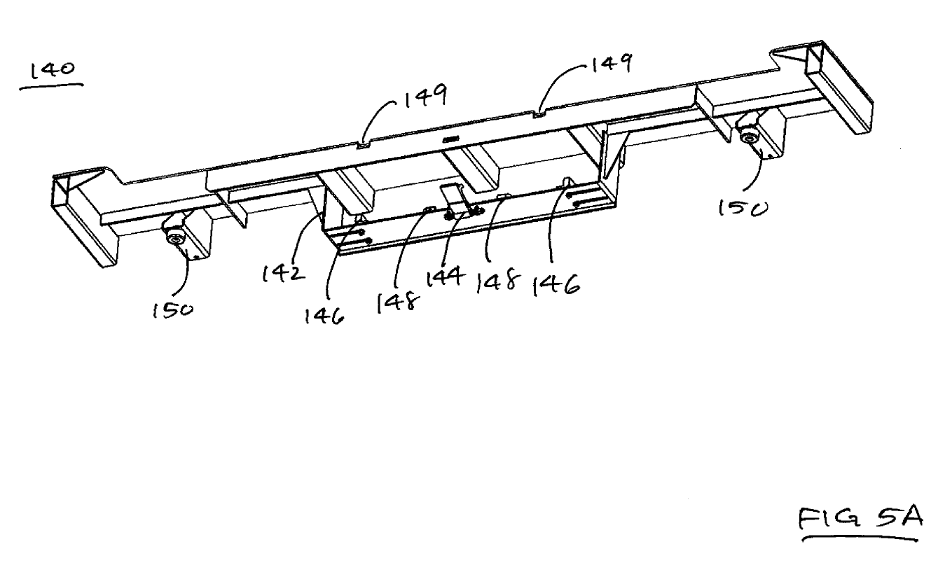

FIGS. 4A-4J show lift 100 in stowed position. FIGS. 4A-4C show isometric views of lift 100. FIGS. 4D-4F show cross-sectional side views of lift 100. FIG. 4G shows an isometric view from beneath lift 100. FIG. 4H shows a back view of lift 100. FIG. 4J shows a top view of lift 100.

As lift 100 is stowed, platform 130 contacts platform stops 150. Platform stops 150 limit how high linkage 120 and platform 130 are raised, and also may minimize movement of platform 130 when vehicle 10 is in motion. Platform stops 150 also maintain a space underneath extension plate 140 when lift 100 is stowed. Platform stops 150 may be coupled to the vehicle bed 15, the extension plate 140, or any other suitable location.

Extension plate 140 may include a ramp guide 142. Ramp 160 may be stored under vehicle bed 15 and extend into ramp guide 142. Lift 100 in stowed position includes a sufficiently large space underneath extension plate 140 such that ramp guide 142 is not blocked and ramp 160 is accessible. Lift 100 thus allows ramp 160 to be used even when lift 100 is completely disabled. This eliminates the need to first lower platform 130 before being able to use ramp 160. This also reduces the possibility of injury from lift 100 moving while ramp 160 is being deployed or stored.

Ramp guide 142 also makes ramp 160 easier to access by allowing ramp 160 to extend beyond the rear of vehicle bed 15 and be stored partially under extension plate 140. This eliminates the need the reach under the extension plate 140 to reach ramp 160. This also reduces the possibility of injury from contact with extension plate 140 or other parts of lift 100 while trying to deploy or store ramp 160.

As can be seen especially in FIGS. 4D and 4J, neither linkage 120 nor platform 130 extends beyond the rear edge of extension plate 140 or extension plate supports 141. This prevents damage to lift 100 when vehicle 10 is backed up against a dock or other structure.

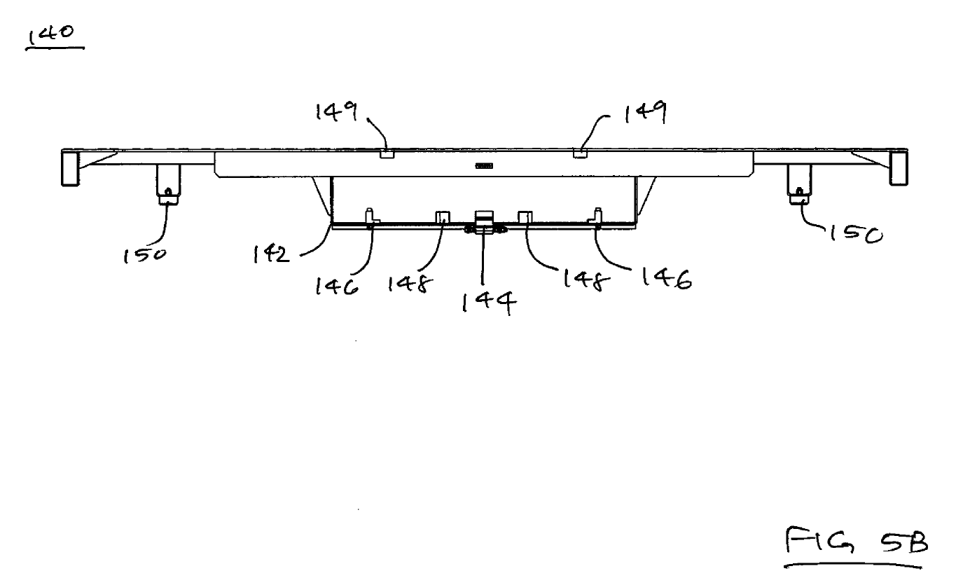

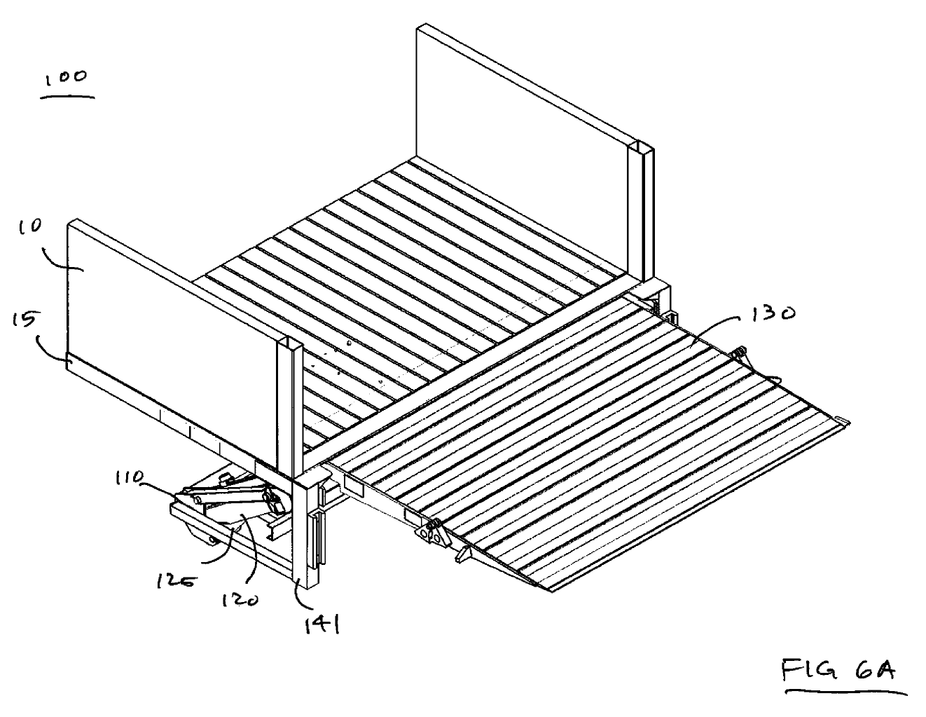

FIGS. 5A-5B show one embodiment of extension plate 140 suitable for use with lift 100. FIG. 5A shows an isometric view of the bottom of extension plate 140. FIG. 5B shows a back view of extension plate 140.

Extension plate 140 is configured so that it meets platform 130 when lift 100 is in bed level position. Extension plate 140 and/or extension plate supports 141 are configured to protect linkage 120 and platform 130 when lift 100 is in stowed position. Extension plate 140 may be configured so that it is compatible with dock plates.

Ramp guide 142 may include a latch 144 which secures ramp 160. Ramp guide 142 may also include glides 146 and retainers 148. When ramp 160 is deployed, the back end of ramp 160 may include hooks 161 which may be latched onto ramp supports 149.

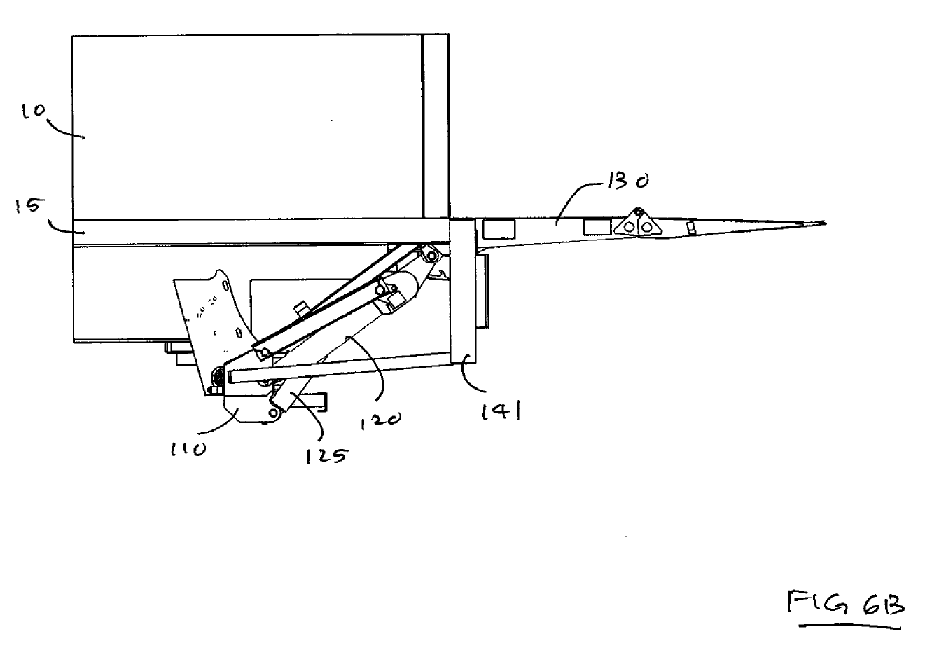

FIGS. 6A-6B show another embodiment of a lift 100 in accordance with the present invention. FIG. 6A shows an isometric view of lift 100. FIG. 6B shows a side view of lift 100.

In this embodiment, lift 100 does not include an extension plate. Vehicle 10 has an extended vehicle bed 15, and so has no need for an extension plate or adapter plate. Lift 100 is configured to work with this extended vehicle bed 15. Platform stops 150 may be coupled to vehicle bed 15. Ramp guide 142, if needed, may be coupled to vehicle bed 15. Ramp 160 is accessible and can be deployed without the need to first move platform 130 from stowed position.

In yet another embodiment not illustrated, lift 100 in stowed position blocks access to ramp 160. Lift 100 includes a limiting device which allows platform 130 to be moved to permit access to a ramp 160, but does not allow lift 100 to be used.

The limiting device may be a controller which allows platform 130 to be lowered enough to allow access to ramp 160, but does not allow platform 130 to be completely lowered and used. For example, the controller may include two settings: a “LIFT OK” setting and a “RAMP ONLY” setting. When lift 100 is set to the “LIFT OK” setting, lift 100 may be unstowed and operated. When lift 100 is set to the “RAMP ONLY” setting, platform 130 may be lowered only enough to create a sufficiently large space underneath extension plate 140 to permit access to ramp 160. The controller may include logic and operate in conjunction with limit switches, sensors, or other feedback devices which control how much platform 130 may be lowered. The controller may include a timer which limits the amount of time actuator 125 may be operated and thus how much platform 130 may be lowered.

The limiting device may be a cylinder stop, where actuator 125 is a hydraulic cylinder. The cylinder stop restricts how much the hydraulic cylinder may shorten. The cylinder stop may be lockable and removed only when the lift 100 is authorized to be used.

The limiting device may also be a chain or other restraint of a suitable length which limits how much platform 130 may be lowered. The chain may be lockable and removed only when the lift 100 is authorized to be used.

Lift 100 may have safety features to prevent injury and damage. As mentioned earlier, lift 100 may have an interlock which prevents platform 130 from being raised when lift 100 is in ground position and ramp 160 is deployed. As another example, lift 100 may have an interlock which prevents ramp 160 from being deployed when lift 100 is unstowed but not in ground position. These safety features may be implemented with limits switches, sensors, or other feedback devices. These safety features may also be implemented as part of the controller.

While the invention has been described in terms of some specific examples and in some specific embodiments, it will be clear that this invention is not limited to these specific examples and embodiments and that many changes and modified embodiments will be obvious to those skilled in the art without departing from the true spirit and scope of the invention as defined in the appended claims.

What is claimed is:

1. A lift suitable for use with a vehicle, the vehicle having a vehicle bed and a ramp stored underneath the vehicle bed, the lift comprising:
a platform capable of carrying cargo, the platform having a stowed position;
a linkage and an actuator coupled to the platform, the linkage and the actuator capable of raising and lowering the platform to and from the vehicle bed;
a frame coupled to the linkage, the frame capable of being coupled to the vehicle;
an extension plate suitable for coupling to the vehicle bed; and
a platform stop configured to maintain a space between the extension plate and the platform in the stowed position, wherein the space is large enough so that the platform in the stowed position does not block access to the ramp.

2. The lift of claim 1, wherein the platform stop is coupled to the extension plate.

3. The lift of claim 1, wherein the platform stop is coupled to the vehicle bed.

4. The lift of claim 1, wherein the linkage and the platform in the stowed position do not extend beyond a rear edge of the extension plate.

5. The lift of claim 1, wherein the extension plate includes a ramp guide, and the ramp is partially stored in the ramp guide.

6. A lift suitable for use with a vehicle, the vehicle having a vehicle bed and a ramp stored underneath the vehicle bed, the lift comprising:
a platform capable of carrying cargo, the platform having a stowed position which blocks access to the ramp;
a linkage and an actuator coupled to the platform, the linkage and the actuator capable of raising and lowering the platform to and from the vehicle bed;
a frame coupled to the linkage, the frame capable of being coupled to the vehicle;
an extension plate suitable for coupling to the vehicle bed; and
means for limiting movement of the platform, the means for restricting allowing the platform in the stowed position to be lowered enough define a space between the extension plate and the platform, wherein the space is large enough so that the platform does not block access to the ramp, and wherein the space is not large enough to allow the platform to be used to carry cargo.

7. The lift of claim 6, wherein the means for limiting is a controller coupled to the actuator.

8. The lift of claim 6, wherein the means for limiting is a timer coupled to the actuator.

9. The lift of claim 6, wherein the actuator is a hydraulic cylinder, and the means for limiting is a cylinder stop coupled to the hydraulic cylinder.

10. The lift of claim 6, wherein the means for limiting is a chain coupled to the platform.

11. A lift suitable for use with a vehicle, the vehicle having a vehicle bed and a ramp stored underneath the vehicle bed, the lift comprising:
a platform capable of carrying cargo, the platform having a stowed position;
a linkage and an actuator coupled to the platform, the linkage and the actuator capable of raising and lowering the platform to and from the vehicle bed;
a frame coupled to the linkage, the frame capable of being coupled to the vehicle; and
a platform stop configured to maintain a space between the vehicle bed and the platform in the stowed position, wherein the space is large enough so that the platform in the stowed position does not block access to the ramp.

12. The lift of claim 11, wherein the platform stop is coupled to the vehicle bed.

13. The lift of claim 11, wherein the linkage and the platform in the stowed position do not extend beyond a rear edge of the vehicle bed.

14. A lift suitable for use with a vehicle, the vehicle having a vehicle bed and a ramp stored underneath the vehicle bed, the ramp capable of being deployed between the vehicle bed and the ground, the lift comprising:
a platform capable of carrying cargo;
a linkage and an actuator coupled to the platform, the linkage and the actuator capable of raising and lowering the platform to and from the vehicle bed;
a frame coupled to the linkage, the frame capable of being coupled to the vehicle;
an extension plate suitable for coupling to the vehicle bed; and
means for preventing the platform from being moved when the ramp is deployed.
